(19) United States
(12) Patent Application Publication
(10) Pub. No.: US 2007/0017315 A1
(43) Pub. Date: Jan. 25, 2007

(54) Gear-change device

(75) Inventors: Filip De Maziere, Heusden (BE); Didier Genouw, Eernegem (BE)

Correspondence Address: SHERIDAN ROSS PC, 1560 BROADWAY, SUITE 1200, DENVER, CO, 80202, US

(73) Assignee: HOERBIGER ANTRIEBSTECHNIK GMBH, Schongau (DE)

(21) Appl. No.: 11/489,132

(22) Filed: Jul. 18, 2006

(30) Foreign Application Priority Data
Jul. 22, 2005 (EP) 05015958.1

(51) Int. Cl. G05G 9/00

(52) U.S. Cl. 74/473.1

(57) ABSTRACT

The present invention relates to a gear-change device (1) comprising a transmission housing (2), at least two neighboring gear shafts (3, 4) arranged in the transmission housing, and a respective gear-change sleeve (5, 6) per gear shaft (3, 4), wherein at least one locking element (7; 8) is arranged on a guide means (9) supported on the transmission housing (2), and by displacement of one (5) of the gear-change sleeves (5, 6) the respectively other one (6) of the gear-change sleeves (5, 6) is locked against an axial displacement on the gear shaft (4) thereof out of the neutral position.

The present invention relates to a gear-change device according to the preamble of claim 1 and to a locking device for gear-change devices according to the preamble of claim 9. Such a gear-change device and such a locking device are known from EP 0 476 005 A.

In gear-change devices, the demand is made for reasons of safety that only one gear should be shifted at a time in the power flow. The other gears are protected from being incorrectly engaged by means of corresponding locks.

In known designs, the locking operations are carried out between the elements that are moved for operating the gear-change sleeves. These may be gear-shift bars, shift rails or selector shafts. With the engagement of a gear, they are locked relative to the housing or a housing-fixed part.

Due to the construction there must be a mechanical operative connection between the respective actuators, such as the gear-shift bars, all the time.

In multi-shaft transmissions, however, it is not always possible for package reasons to arrange the elements for the shifting operation in the housing such that a mechanical operative connection for mutual locking can be establisned in an easy way. For the mutual locking of gear-shift bars that are positioned far away from one another, a complicated mechanism would therefore be required that would be disadvantageous for reasons of costs, weight and also tolerances.

It is therefore the object of the present invention to provide a gear-change device and a locking device of the type indicated in the preamble of claim 9, which offer a simple locking possibility also for transmission designs with shifting elements spatially located far away from one another and which particularly fulfill the function of reliably preventing the engagement of another gear in the torque flow.

This object is achieved by the features of claim 1 and of claim 9, respectively.

While in multi-shaft transmissions the shifting elements may be spatially arranged far apart from one another, the gear-change sleeves to be operated are close to one another almost all the time. According to the invention this fact is exploited in a particularly advantageous and simple way in that the gear-change sleeves are directly locked relative to one another by means of the locking device according to the invention.

In a first embodiment of the gear-change device according to the invention and of the locking device according to the invention, respectively, at least one locking element is arranged on a guide means in such a manner that upon operation of one of the gear-change sleeves on the associated gear shaft out of the neutral position the locking element is radially displaced towards the gear-change sleeve positioned on the opposite gear shaft. The shape of the locking element is here chosen such that the gear-change sleeve to be locked is axially fixed in the neutral position for a period of time during which the actuated gear-change sleeve is positioned outside its neutral position. The engagement of a gear by means of the locked gear-change sleeve is thereby prevented in an efficient manner.

The locking element itself is supported via an appropriate guide means, which is independent of the shifting element, relative to the fixed transmission housing. The locking element may perform a translational movement. The gear-change sleeve and the locking element are each configured such that an axial displacement of a gear-change sleeve effects a translational movement of the locking element perpendicular thereto, but a pushing back of the lock by way of force introduction via the second locked gear-change sleeve is prevented.

Inversely, as long as the previously operated gear-change sleeve is again in its neutral position, the locking element will be radially displaced in opposite direction upon operation of the respectively other gear-change sleeve, and the gear-change sleeve positioned in its neutral position will thus be locked.

In an alternative embodiment, the locking element may be pivotably supported on a guide means. In this embodiment, upon operation of one of the gear-change sleeves the locking element will be rotated about its guide means in such a manner that the respectively other gear-change sleeve will be locked. The gear-change sleeve and the locking element are here configured such that an axial displacement of a gear-change sleeve effects a rotation of the locking element, but a pushing back of the locking element by force introduction via the other gear-change sleeve is prevented as long as the actuated gear-change sleeve is fully pushed out of the neutral position.

Hence, both of the previously described embodiments are capable of reliably preventing an incorrect shifting of a further gear in the presence of a torque flow.

Subclaims 2 to 8 refer to advantageous developments of the gear-change device according to the invention.

In claim 9, the locking device is defined as an independently tradable object.

Claim 10 refers to advantageous developments of the locking device according to the invention, in compliance with the features of claims 2 to 8.

Further details, features and advantages of the invention become apparent from the subsequent description of embodiments with reference to the drawings.

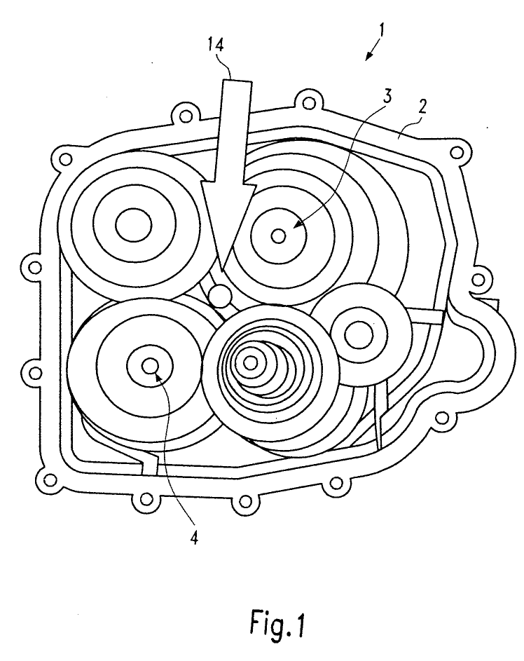

FIG. 1 shows a schematic, slightly simplified illustration of an embodiment of a gear-change device according to the invention;

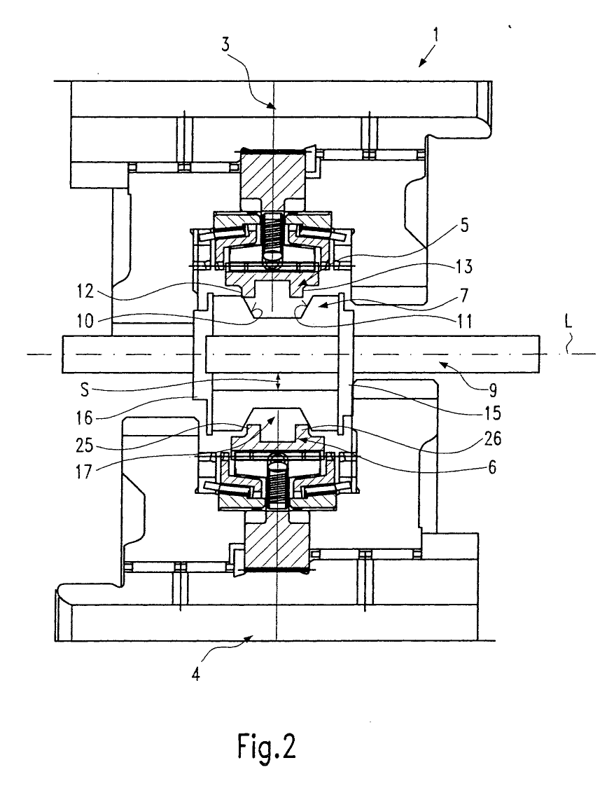

FIG. 2 is a detail view of the gear-change device according to FIG. 1 for the explanation of a first embodiment of the locking device according to the invention;

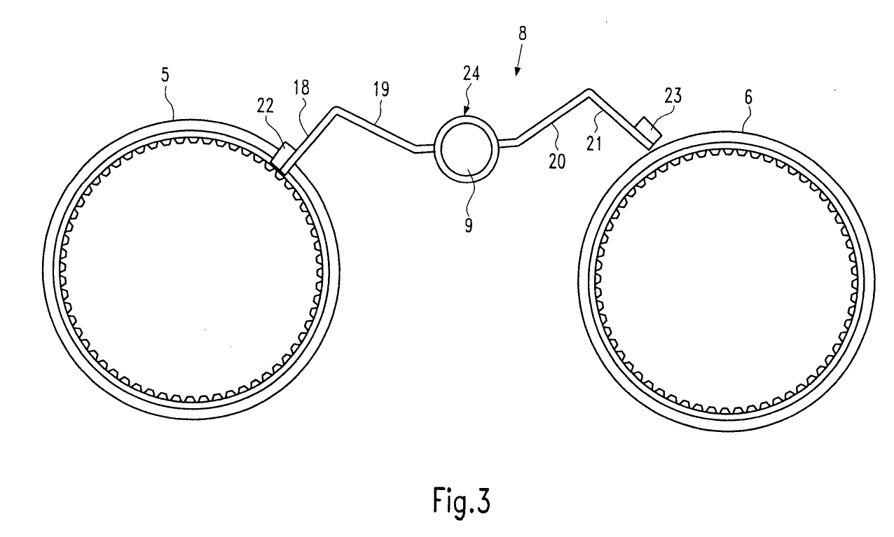

FIG. 3 is a front view of a second embodiment of the locking device according to the invention;

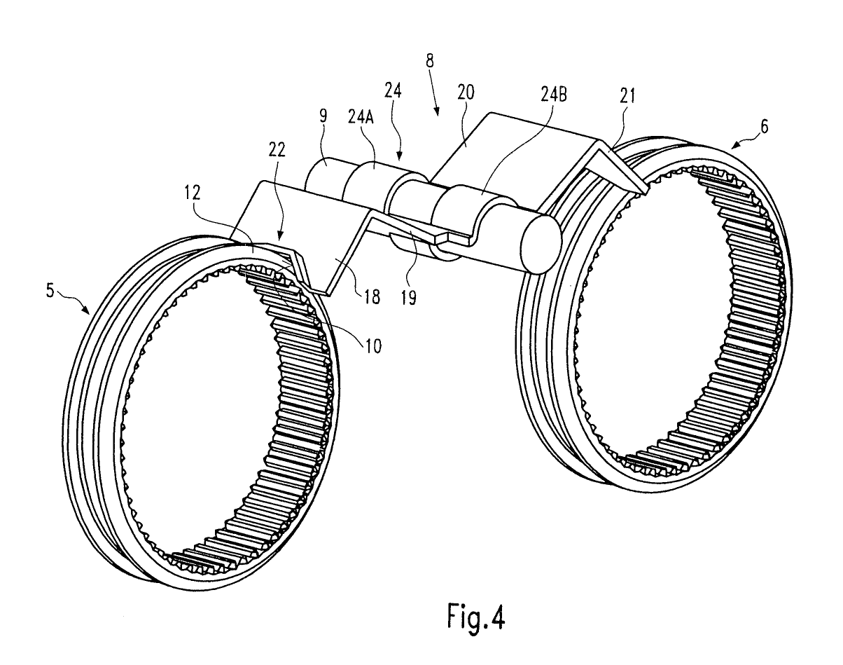

FIG. 4 is a perspective illustration of the locking device according to FIG. 3; and

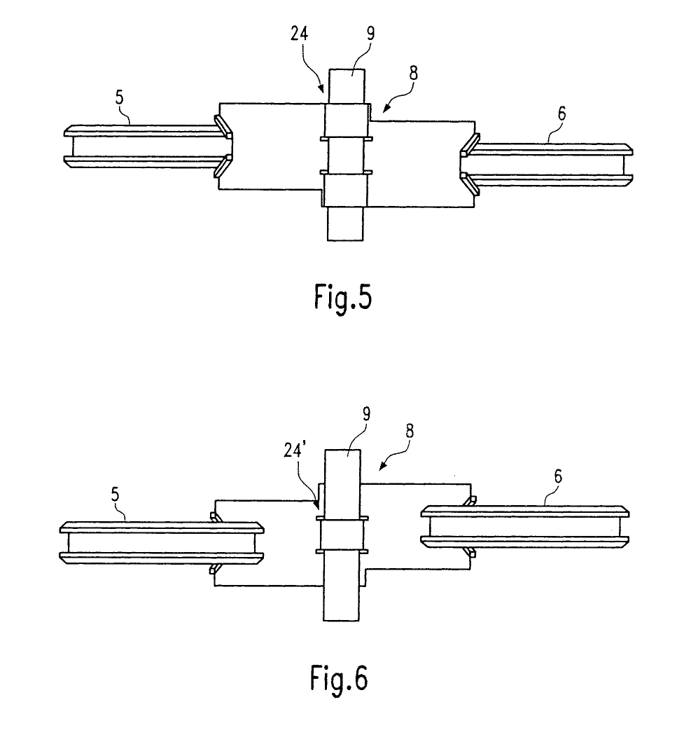

FIGS. 5 and 6 are top views on the locking device according to FIGS. 3 and 4 and of an alternative embodiment of said locking device.

In FIG. 1, an inventive gear-change device 1, particularly in the form of an automatic transmission, is shown in a schematically slightly simplified way to illustrate the position of the locking device 14 of the invention inside the transmission. The gear-change device 1 comprises a transmission housing 2 in which in the example two gear shafts 3 and 4 are arranged.

The locking device 14, which is represented by the arrow, is arranged between the gear shafts 3 and 4, so that a mutual locking of the gear-change sleeves arranged on the gear shafts 3 and 4 is made possible, which shall be explained in the following in more detail. It goes without saying that the gear-change device 1 comprises all of the other components of a gear-change device, the description of which is here however omitted because they play no role in the explanation of the principles of the present invention.

FIG. 2 shows a detail of the gear-change device 1 of the invention, from which the gear shafts 3 and 4 can again be seen extending spaced apart from and in parallel with each other. A gear-change sleeve 5 is arranged on the gear shaft 3 and a gear-change sleeve 6 on the gear shaft 4. A guide means 9 is arranged between the gear shafts 3 and 4, the guide means being possibly connected as a guide rod, for instance with a round cross-section, and supported in the transmission housing 2. In the first embodiment of the inventive locking device 14 and of the inventive gear-change device 1, which is shown in FIG. 2, the guide rod 9 has arranged thereon a locking element 7 that is held via fixing elements 15 and 16 on the guide rod 9, so that the locking element 7 along the longitudinal axis L of the guide rod 9 is stationarily arranged on said rod.

As illustrated in FIG. 2, the locking element 7, however, is displaceable in a radial translational manner because it is arranged with a play S on the guide rod 9, so that a movement in a direction transverse to the extension of the longitudinal axis L is possible.

For the performance of such a movement the locking element 7 comprises guiding surfaces 10 and 11 that in the illustrated embodiment are part of a frustoconical groove 17 in the locking element 7.

Said guiding surfaces 10 and 11 may get into operative communication with corresponding complementary surfaces 12 and 13 of the gear-change sleeve 5 and 25 and 26, respectively, of the gear-change sleeve 6. In the illustrated embodiments the guide surfaces 10, 11 are configured such that they are inclined, resulting upon displacement of one of the gear-change sleeves, in FIG. 2 of the gear-change sleeve 5, along the associated gear shaft 3 in a relative movement on account of the engagement between the guiding surfaces and the complementary surfaces, which in the case of the displacement of the gear-change sleeve 6 as shown in FIG. 2 leads to a movement of the locking element 7 in downward direction onto the gear-change sleeve 6 since the locking element is axially fixed. This results in a fixation of the gear-change sleeve 6 in its neutral position because on account of the translational transverse displacement of the locking element 7 into the position shown in FIG. 2 the guide surfaces 10 and 11 and the associated complementary surfaces 25 and 26 effect a clamping operation which ensures that even upon the application of forces to the gear-change sleeve 6 said sleeve can reliably be held in its neutral position as long as the gear-change sleeve 5 is arranged outside its neutral position, so that the unintended engagement of a second gear is reliably prevented.

When the gear-change sleeve 5 returns into its neutral position and the gear-change sleeve 6 is operated, a translational movement of the locking element in FIG. 2 takes place in a corresponding manner in upward direction, i.e. again in a direction transverse to the longitudinal extension of the longitudinal axis L, so that the gear-change sleeve 5 can be fixed in its neutral position by clamping the guiding and complementary surfaces as long as the gear-change sleeve 6 is arranged outside its neutral position.

Although in the embodiment illustrated in FIG. 2 the guiding surfaces 10 and 11 are inclined, it is of course also possible that the corresponding complementary surfaces of the gear-change sleeves 5 and 6 are given an inclined shape because with such a configuration and arrangement the above-described relative movement of the locking element 7 is also possible upon an axial movement of one of the gear-change sleeves 5 or 6.

FIGS. 3 and 4 show an alternative embodiment of the locking element that is marked in these figures with the reference numeral 8.

In this embodiment, the locking element is configured as a rocker and pivotably arranged around the guide rod 9. As is particularly illustrated in FIG. 3, the locking element 8, which is designed as a rocker, has an M-like configuration in this embodiment and thus comprises rocker arms 18 and 19 and 20 and 21, respectively, arranged at an acute angle relative to one another, at the free ends of which engagement areas 22 and 23, respectively, are arranged. A pivot guide means 24 which is supported on the guide rod 9 with a round cross-section is arranged between the pairs of rocker arms.

The perspective illustration of FIG. 4 shows that in this embodiment, which in top view is also illustrated in FIG. 5, the pivot guide means 24 comprises two guide areas 24a and 24b, respectively, which are arranged side by side.

FIG. 4 further illustrates the operative mechanism of the guiding surfaces, which are also provided in this embodiment, of the locking element 8, of which surfaces only the guiding surface 10 is visible due to the chosen illustration. This surface cooperates with a complementary surface 12 of the gear-change sleeve 5. An engagement area 23 of the rocker arm 21 is designed accordingly, which is however not visible in more detail due to the illustration chosen in FIG. 4.

FIG. 4, however, illustrates that in this embodiment the guiding surface 10 is inclined and is part of a groove, which is again frustoconical, in the rocker arm 18.

This makes it possible to perform a pivotal movement upon axial displacement of one of the two gear-change sleeves 5 and 6 by way of the resulting relative movement between the guiding and complementary surfaces so that, depending on which one of the two gear-change sleeves is moved axially out of its neutral position, the axially stationary locking element 8 is pivoted around the guide rod 9, and the corresponding engagement area 22 and 23, respectively, thereby gets into operative communication with the associated gear-change sleeve 5 or 6, and secures the same, in turn, in its neutral position by a clamping force being built up. In the illustration of FIG. 3, the gear-change sleeve 6 is secured in its neutral position because the engagement area 22 is in engagement with the associated gear-change sleeve surfaces.

Upon operation of the respectively other gear-change sleeve, a rotation is performed into the other direction, so that the opposite other gear-change sleeve will then be secured in the neutral position.

FIG. 6 additionally shows an embodiment of a locking element 8′ which comprises a pivot guide means 24′ with just one pivot area that is arranged on the guide rod 9. Otherwise, the mode of operation of this embodiment corresponds to the previously explained mode of operation of the embodiment according to FIGS. 3 to 5.

Thus, the locking device 14 according to the invention makes it possible in a very simple way to lock the gear-change sleeves directly so as to prevent a situation where in the torque flow another gear or several other gears are engaged. Both in the previously explained translational movement of the locking element and of the pivotal movement of the locking element at least one second gear-change sleeve is locked relative to the housing, resulting in a reliably operating locking device of a simple construction even in the case of gear-shift bars, shift rails or selector shafts that are spaced far apart from one another, on account of the principles of the present invention.

### LIST OF REFERENCE NUMERALS

1 Gear-change device (transmission), particularly automatic transmission
2 transmission housing
3, 4 gear shaft
5, 6 gear-change sleeves
7, 8, 8′ locking element
9 guide means, guide rod
10, 11 guiding surface
12, 13, 25, 26 complementary surface
14 locking device
15, 16 fixing element
17 frustoconical groove
18, 19, 20, 21 rocker arms
22, 23 engagement area
24, 24′ pivot guide means
24a, 24b pivot guide areas

1. A gear-change device comprising:
a transmission housing;
at least two neighboring gear shafts arranged in the transmission housing;
a respective gear-change sleeve per gear shaft; and
at least one locking element arranged on a guide means supported on the transmission housing,
wherein by displacement of at least one gear-change sleeve the locking element locks the respectively other one of the gear-change sleeves against an axial displacement on one of said two neighboring gear shafts thereof out of the neutral position.

2. The gear-change device according to claim 1, wherein the locking element is axially fixed on the guide means said guide means having a longitudinal axis and wherein said locking element is guided in a direction transverse to the longitudinal axis of the guide means with a play.

3. The gear-change device according to claim 2, wherein the locking element comprises at least one guiding surface which can be brought into operative communication with at least one complementary surface on the gear-change sleeve for producing a translational locking movement in a direction transverse to the longitudinal axis of the guide means towards the gear-change sleeve to be locked upon an axial shifting movement of the respectively other gear-change sleeve.

4. The gear-change device according to claim 1, wherein the locking element is pivotably arranged on the guide means.

5. The gear-change device according to claim 4, wherein the locking element comprises at least one guiding surface which can be brought into operative communication with at least one complementary surface on the gear-change sleeve for producing a pivotal locking movement around the guide means towards the gear-change sleeve to be locked upon an axial shifting movement of the respectively other gear-change sleeve.

6. The gear-change device according to claim 4 wherein the locking element is configured as an approximately M-shaped rocker.

7. The gear-change device according to claim 1, wherein the guide means is arranged between the gear shafts in the transmission housing.

8. The gear-change device according to claim 1, wherein the guide means operatively positioned in the transmission housing is configured as a guide rod. 8

9. A locking device for gear-change devices comprising a transmission housing, at least two gear shafts arranged next to each other in the transmission housing, and one respective gear-change sleeve per gear shaft, wherein at least one locking element is arranged on a guide means supported on the transmission housing and by axial displacement of one of the gear-change sleeves can be brought into locking engagement with the respectively other gear-change sleeve.

10. The locking device according to claim 9, wherein at least one locking element has a substantially M-shaped rocker.
